(19) United States
(12) Patent Application Publication
(10) Pub. No.: US 2013/0297779 A1
(43) Pub. Date: Nov. 7, 2013

(54) ELECTRONIC DEVICE AND METHOD FOR DETECTING NETWORK CONNECTION BETWEEN THE ELECTRONIC DEVICE AND NETWORK

(71) Applicant: CHI MEI COMMUNICATION SYSTEMS, INC., New Taipei (TW)

(72) Inventors: Yun-Long SIE, New Taipei (TW); Her-Ching SHYU, New Taipei (TW)

(73) Assignee: Chi Mei Communication Systems, Inc., New Taipei (TW)

(21) Appl. No.: 13/858,089

(22) Filed: Apr. 7, 2013

(30) Foreign Application Priority Data
May 4, 2012 (TW) 101115898

(51) Int. Cl. H04L 12/26

(52) U.S. Cl. CPC H04L 43/0811
USPC 709/224

(57) ABSTRACT

In a method for detecting a network connection between an electronic device and a network, the method firstly records in real time busy time periods and idle time periods of the network connection. Secondly, the method adjusts a detection frequency of a current time period to meet a need of the current time period, and computes all of the network detection time. At last, the method detects the network connection when a current time is same as the network detection time, and builds a new network connection between an electronic device and a network when the network connection between the electronic device and the network is disconnected.

### BACKGROUND

1. Technical Field

The embodiments of the present disclosure relate to detection systems and methods, and more particularly to an electronic device and method for detecting a network connection between the electronic device and a network.

2. Description of Related Art

A network connection between an electronic device and a network is usually detected by a constant frequency predefined by a user of the electronic device. However, the constant frequency can not be adjusted automatically to meet different needs of different time periods. For example, an idle time period when there are no data communicated between the electronic device and the network, needs a less frequency to avoid power loss of the electronic device, and a busy time period when there are data communicated between the electronic device and the network needs a higher frequency to guarantee the data communication is fast and accurate.

### BRIEF DESCRIPTION OF THE DRAWINGS

FIG. 1 is a block diagram of one embodiment of an electronic device including a network connection detection system.

FIG. 2 is a block diagram of one embodiment of function modules of the network connection detection system in FIG. 1.

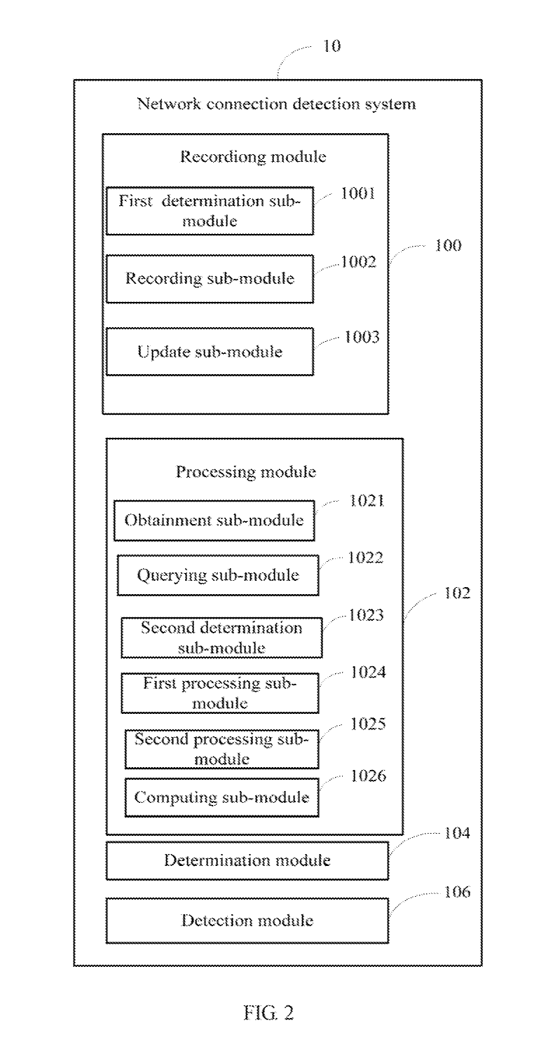

FIG. 3 is a flowchart of one embodiment of a method for detecting a network connection between an electronic device and a network.

FIG. 4 is a flowchart of one embodiment of block 5200 of FIG. 4.

FIG. 5 is a flowchart of one embodiment of block 5202 of FIG. 4.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

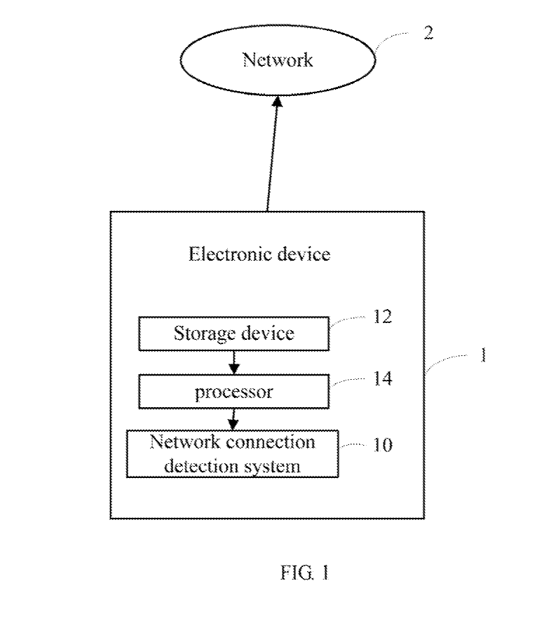

FIG. 1 is a block diagram of one embodiment of an electronic device 1 including a network connection detection system 10. In the embodiment, the electronic device 1 connects to a network 2 (e.g., Internet, local area network), and may further include a storage device 12, at least one processor 14. The electronic device 1 may be a smart phone, a PDA device, or a tablet computer, for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the network connection detection system 10 includes a plurality of function modules which include computerized codes or instructions that can be stored in the storage device 12 and executed by the at least one processor 14 to provide a method for detecting a network connection between the electronic device 1 and the network 2.

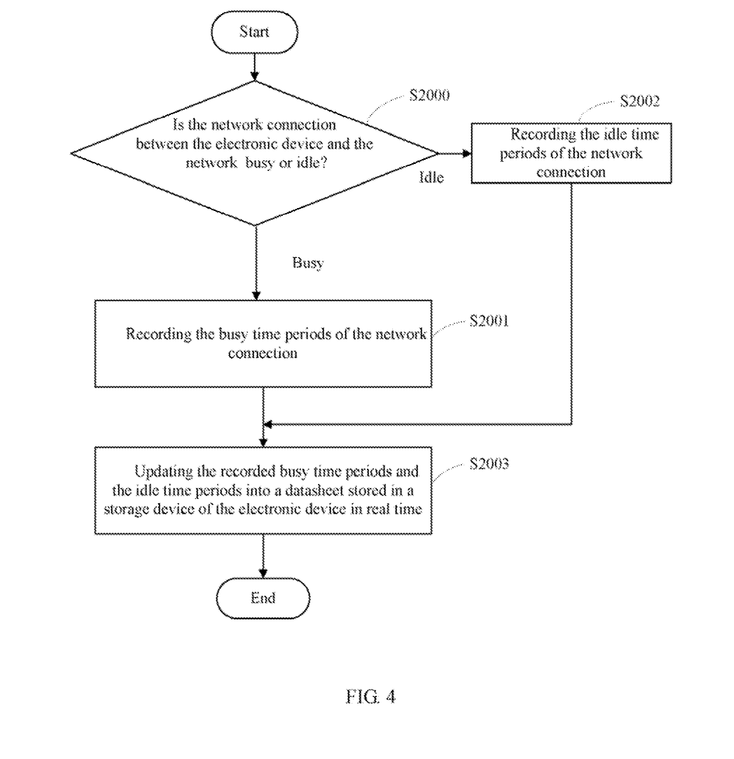

In one embodiment, the network connection detection system 10 may include a recording module 100, a processing module 102, a determination module 104, and a detection module 106. In the embodiment, the recording module 100 may include a first determination sub-module 1001, a recording sub-module 1002, and an update sub-module 1003. The processing module 102 may include an obtainment sub-module 1021, a querying sub-module 1022, a second determination sub-module 1023, a first processing sub-module 1024, a second processing sub-module 1025, and a computing sub-module 1026. The modules may comprise computerized codes in the form of one or more programs that are stored in the storage device 12 and executed by the at least one processor 14 to provide functions for implementing the modules. The functions of the function modules are illustrated in FIG. 4 and described below.

FIG. 4 illustrates a flowchart of one embodiment of a method for detecting a network connection between the electronic device 1 and the network 2. Depending on the embodiment, additional steps may be added, others removed, and the ordering of the steps may be changed.

In block S200, the recording module 100 records busy time periods and idle time periods of the network connection between the electronic device 1 and the network 2 in real time. In the embodiment, the busy time periods may be time periods when the electronic device 1 communicates with the network 2 (e.g., data being transferred from/to the electronic device 1 using the network 2), and the idle time periods may be time periods when the electronic device 1 does not communicate with the network 2 (e.g., data not being transferred from/to the electronic device 1 using the network 1). In one embodiment, the data being transferred has to be over a certain byte size before being determined as an idle time period.

In block 5202, the processing module 102 adjusts a detection frequency of a current time period for detecting the network connection between the electronic device 1 and the network 2 according to the busy time periods and the idle time periods, and computes a network detection time according to the adjusted detection frequency of the current time period. In the embodiment, the network detection time may be computed as 1:10, 2:20, 3:20, . . . , 12:00, for example.

In block 5204, the determination module 104 determines whether a current time is same as the network detection time.

In block 5206, when the current time is same as the network detection time, the detection module 106 detects the network connection between the electronic device 1 and the network 2, and builds a new network connection between the electronic device and the network if the network connection between the electronic device 1 and the network 2 is disconnected. Otherwise, when the current time does not arrive the network detection time, the detection module 106 keeps waiting for the network detection time. In the embodiment, the network connection may be detected using a ping detection command or a ACK detection command.

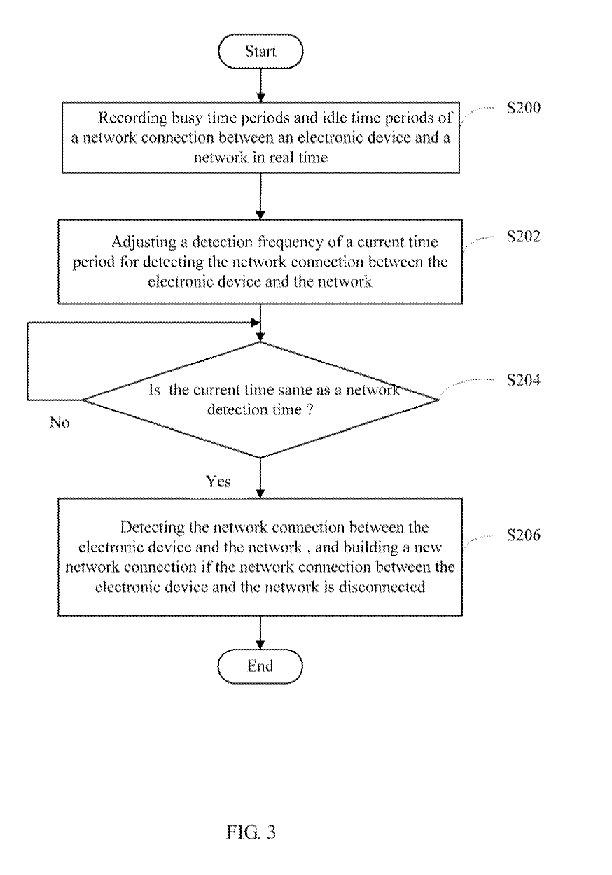

FIG. 4 illustrates a flowchart of one embodiment of the block 5200 in FIG. 3. Depending on the embodiment, additional steps may be added, others removed, and the ordering of the steps may be changed.

In block S2000, the first determination sub-module 1001 determines whether the network connection between the electronic device 1 and the network 2 is busy or idle.

In block S2001, if the network connection between the electronic device 1 and the network 2 is busy, the recording sub-module 1002 records the busy time periods of the network connection.

In block S2002, if the connection between the electronic device 1 and the network 2 is idle, the recording sub-module 1002 records the idle time periods of the network connection.

In block S2003, the update sub-module 1003 updates the busy time periods and the idle time periods into a datasheet stored in the storage device 12 in real time.

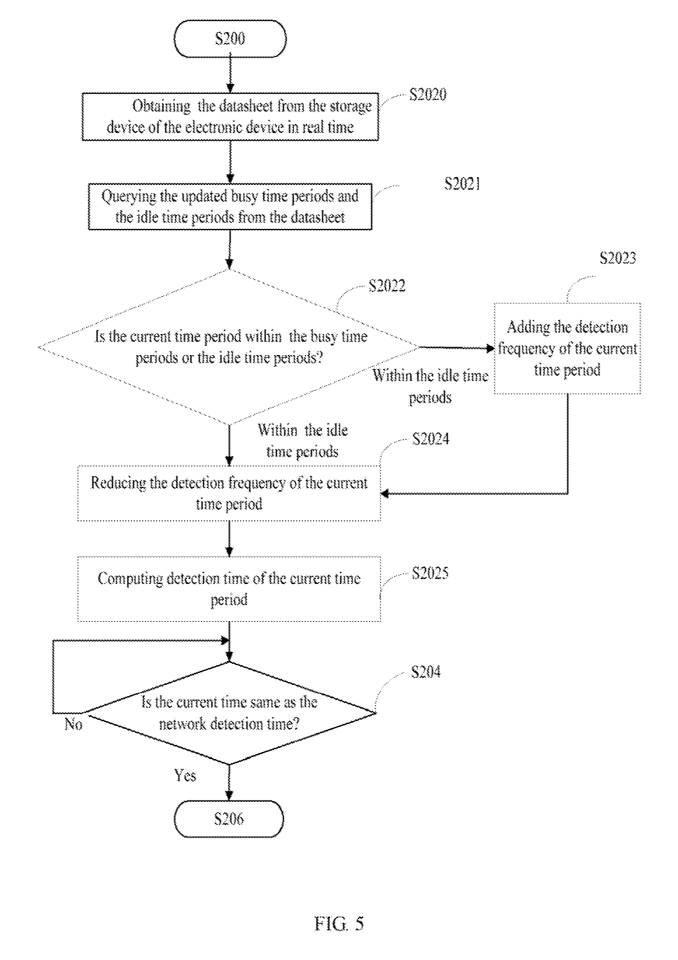

FIG. 5 illustrates a flowchart of one embodiment of the block S202. Depending on the embodiment, additional steps may be added, others removed, and the ordering of the steps may be changed.

In block S2020, the obtainment sub-module 1021 obtains the datasheet from the storage device 12 in real time.

In block S2021, the querying sub-module 1022 queries the updated busy time period and the idle time period from the datasheet.

In block S2022, a second sub-determination module 1023 determines whether the current time period is within the busy time periods or is within the idle time periods.

In block S2023, the first processing sub-module 1024 adds the detection frequency of the current time period if the current time period is within the busy time periods.

In block S2024, the second processing sub-module 1025 reduces the detection frequency of the current time period if the current time period is within the idle time periods.

In block S2025, the computing sub-module 1026 computes all of the network detection time of the current time period according to the adjusted detection frequency of the current time period, and enters the step 204.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device for detecting a network connection between the electronic device and a network, the electronic device comprising:
a storage device;
at least one processor; and
one or more programs stored in the storage device and executed by the at least one processor, the one or more programs comprising:
a recording module that records busy time periods and idle time periods of the network connection between the electronic device and the network in real time, wherein the busy time periods are time periods when the electronic device communicates with the network, and the idle time periods are time periods when the electronic device does not communicate with the network;
a processing module that adjusts a detection frequency of a current time period for detecting the network connection between the electronic device and the network according to the busy time periods and the idle time periods, and computes a network detection time according to the detection frequency of the current time period; and
a detection module that detects the network connection between the electronic device and the network when a current time is same as the network detection time, and builds a new network connection between the electronic device and the network if the network connection between the electronic device and the network is disconnected.

2. The electronic device according to claim 1, wherein the recording module comprises:
a first determination sub-module that determines whether the network connection between the electronic device and the network is busy or idle;
a recording sub-module that records the busy time periods of the network connection if the network connection between the electronic device and the network is busy, and records the idle time periods of the network connection if the network connection between the electronic device and the network is idle; and
an update sub-module that updates the busy time periods and the idle time periods into a datasheet stored in the storage device in real time.

3. The electronic device according to claim 1, wherein the processing module comprises:
an obtainment sub-module that obtains the datasheet from the storage device in real time;
a querying sub-module that queries the updated busy time periods and the updated idle time periods from the datasheet;
a second determination sub-module that determines whether the current time period is within the busy time periods or the idle time periods;
a first processing sub-module that adds the detection frequency of the current time period if the current time period is within the busy time period;
a second processing sub-module that reduces the detection frequency of the current time period if the current time period is within the idle time period; and
a computing sub-module that computes all of the network detection time of the current time period according to the adjusted detection frequency of the current time period.

4. The electronic device according to claim 1, wherein the network connection is detected using a ping detection command or an ACK detection command.

5. A method for detecting a network connection between the electronic device and a network, the method comprising:
(a) recording busy time periods and idle time periods of the network connection between the electronic device and the network in real time, wherein the busy time periods are time periods when the electronic device communicates with the network, and the idle time periods are time periods when the electronic device does not communicate with the network;
(b) adjusting a detection frequency of a current time period for detecting the network connection between the electronic device and the network according to the busy time periods and the idle time periods, and computing a network detection time according to the detection frequency of the current time period; and
(c) detecting the network connection between the electronic device and the network when a current time is same as the network detection time, and building a new network connection between the electronic device and the network if the network connection between the electronic device and the network is disconnected.

6. The method according to claim 5, wherein the step (a) comprises:
determining whether the network connection between the electronic device and the network is busy or idle;
recording the busy time periods of the network connection if the network connection between the electronic device and the network is busy, and recording the idle time periods of the network connection if the network connection between the electronic device and the network is idle; and
updating the busy time periods and the idle time periods into a datasheet stored in the storage device in real time.

7. The method according to claim 5, wherein the step (b) comprises:
obtaining the datasheet from the storage device in real time;
querying the updated busy time periods and the updated idle time periods from the datasheet;
determining whether the current time period is within the busy time periods or the idle time periods;
adding the detection frequency of the current time period if the current time period is within the busy time period;
reducing the detection frequency of the current time period if the current time period is within the idle time period; and
computing all of the network detection time of the current time period according to the adjusted detection frequency of the current time period.

8. The method according to claim 5, wherein the network connection is detected using a ping detection command or an ACK detection command.

9. A non-transitory computer-readable storage medium having stored thereon instructions being executed by a processor of an electronic device, causes the electronic device to perform a method for detecting a network connection between the electronic device and a network, the method comprising:
(a) recording busy time periods and idle time periods of the network connection between the electronic device and the network in real time, wherein the busy time periods are time periods when the electronic device communicates with the network, and the idle time periods are time periods when the electronic device does not communicate with the network;
(b) adjusting a detection frequency of a current time period for detecting the network connection between the electronic device and the network according to the busy time periods and the idle time periods, and computing a network detection time according to the detection frequency of the current time period; and
(c) detecting the network connection between the electronic device and the network when a current time is same as the network detection time, and building a new network connection between the electronic device and the network if the network connection between the electronic device and the network is disconnected.

10. The storage medium according to claim 9, wherein the step (a) comprises:
determining whether the network connection between the electronic device and the network is busy or is idle;
recording the busy time periods of the network connection if the network connection between the electronic device and the network is busy, and recording the idle time periods of the network connection if the network connection between the electronic device and the network is idle; and
updating the busy time periods and the idle time periods into a datasheet stored in the storage device in real time.

11. The storage medium method according to claim 9, wherein the step (b) comprises:
obtaining the datasheet from the storage device in real time;
querying the updated busy time periods and the updated idle time periods from the datasheet;
determining whether the current time period is within the busy time periods or the idle time periods;
adding the detection frequency of the current time period if the current time period is within the busy time period;
reducing the detection frequency of the current time period if the current time period is within the idle time period; and
computing all of the network detection time of the current time period according to the adjusted detection frequency of the current time period.

12. The storage medium according to claim 9, wherein the network connection is detected using a ping detection command or an ACK detection command.
